(19) United States
(12) Patent Application Publication
(10) Pub. No.: US 2025/0330943 A1
(43) Pub. Date: Oct. 23, 2025

(54) METHOD, SYSTEM, AND CONTROL UNIT FOR DETERMINING A POSITION OF A FIRST WIRELESS DEVICE IN AN UNDERGROUND ENVIRONMENT

(71) Applicant: EPIROC ROCK DRILLS AKTIEBOLAG, Örebro (SE)

(72) Inventors: Hans WAHLQUIST, Örebro (SE); Tobias MÄKITALO, Örebro (SE)

(21) Appl. No.: 18/870,621

(22) PCT Filed: Jun. 2, 2022
(86) PCT No.: PCT/SE2022/050535

§ 371 Date: Nov. 29, 2024

(51) Int. Cl. H04W 64/00

(52) U.S. Cl. CPC H04W 64/00

(57) ABSTRACT

A method for determining a position of a first wireless device in an underground environment is provided. The method includes obtaining a plurality of position estimations of the first wireless device in the underground environment. The plurality of position estimations are obtained from different positioning services. The method further includes obtaining quality indicators indicating respective qualities of the plurality of position estimations in the underground environment. The method further includes selecting a position estimation out of the plurality of position estimations based on the obtained quality indicators. The method further includes determining the position of the first wireless device based on the selected position estimation.

### TECHNICAL FIELD

Embodiments herein relate to a method, a system and a control unit for determining a position of a first wireless device in an underground environment. Furthermore, a computer program and a carrier are also provided herein.

### BACKGROUND

There exist various situations in which it may be desirable to accurately determine the position of an object. With regards to outdoor positioning, satellite based positioning systems, such as Global Positioning System (GPS) are often utilized. However, often there is a desire to accurately position objects also in environments where satellite-based positioning systems may not be utilized, such as in underground environments. For example, objects for which an accurate positioning may be desirable may be a machine, a vehicle and/or a wireless device carried by a human, operating in a mine or a tunnel, or any other kind of objects operating in environments where satellite positioning is not available or not accurate enough, e.g. in storage facilities such as warehouses. The positioning systems being used in such environments is typically based on use of radio technology. A common technique is for example to use triangulation based on signal strength measurements from different access points with known locations. However, it may be difficult for radio signals to propagate in these environments, e.g. due to thick rock walls in underground environments. Therefore it may be difficult to find the objects at all times, and even if they are located, accuracy of the location may be poor. Another issue is that when vehicles pass by wireless devices transmitting or receiving radio signals, the radio signals may be distorted which may cause more inaccuracies for positioning services. Furthermore, underground environments constantly change due to various mining activities. Hence, automatic positioning is always associated with a degree of uncertainty. Hence, there is an ongoing strive for locating objects in underground environments.

### SUMMARY

An object of embodiments herein is to improve an accuracy and/or an efficiency of locating an object in an underground environment.

According to a first aspect, a method for determining a position of a first wireless device in an underground environment is provided. The method comprises obtaining a plurality of position estimations of the first wireless device in the underground environment. The plurality of position estimations are obtained from different positioning services. The method further comprises obtaining quality indicators indicating respective qualities of the plurality of position estimations in the underground environment. The method further comprises selecting a position estimation out of the plurality of position estimations based on the obtained quality indicators. The method further comprises determining the position of the first wireless device based on the selected position estimation.

Since the quality indicators indicate respective quality of the plurality of position estimations in the underground environment, it is enabled to select the position estimation out of the plurality of position estimations with the best indicated quality. In this way, it is possible to determine the position of the first wireless device based on the position estimation with the highest quality out of the plurality of position estimations.

According to a second aspect, a control unit configured to determine a position of a first wireless device in an underground environment is provided. The control unit is further configured to obtain a plurality of position estimations of the first wireless device in the underground environment. The plurality of position estimations are obtained from different positioning services. The control unit is further configured to obtain quality indicators indicating respective qualities of the plurality of position estimations in the underground environment. The control unit is further configured to select a position estimation out of the plurality of position estimations based on the obtained quality indicators. The control unit is further configured to determine the position of the first wireless device based on the selected position estimation. Advantages and effects of the control unit are largely analogous to the advantages and effects of the method of the first aspect. Further, all embodiments of the control unit are applicable to and combinable with all embodiments of the method of the first aspect, and vice versa.

According to a third aspect, a system comprising a control unit and a first wireless device is provided. The system is configured to perform the method according to the first aspect. Advantages and effects of the system are largely analogous to the advantages and effects of the method of the first aspect and/or the control unit of the second aspect. Further, all embodiments of the system are applicable to and combinable with all embodiments of the method of the first aspect and/or the control unit of the second aspect, and vice versa.

According to a fourth aspect, a computer program comprising instructions, which when executed by a processor, causes the processor to perform actions according to the first aspect. Advantages and effects of the computer program are largely analogous to the advantages and effects of the method of the first aspect. Further, all embodiments of the computer program are applicable to and combinable with all embodiments of the method of the first aspect, and vice versa.

According to a fifth aspect, a carrier comprising the computer program according to the fourth aspect, wherein the carrier is one of an electronic signal, an optical signal, an electromagnetic signal, a magnetic signal, an electric signal, a radio signal, a microwave signal, or a computer-readable storage medium. Advantages and effects of the carrier are largely analogous to the advantages and effects of the method of the first aspect. Further, all embodiments of the carrier are applicable to and combinable with all embodiments of the method of the first aspect, and vice versa.

Further advantages and advantageous features of embodiments herein are disclosed in the following detailed description and in the dependent claims.

### BRIEF DESCRIPTION OF THE DRAWINGS

Examples of embodiments herein are described in more detail with reference to attached drawings in which:

FIG. 1 is a schematic block diagram illustrating a scenario according to embodiments herein.

FIG. 2 is a flowchart depicting a method according to embodiments herein.

FIG. 3 is a schematic block diagram illustrating embodiments herein.

FIG. 4 is a schematic block diagram illustrating embodiments herein.

FIG. 5 is a schematic block diagram illustrating embodiments herein.

FIG. 6 is a schematic block diagram illustrating embodiments herein.

FIG. 7 is a schematic block diagram illustrating embodiments herein.

FIGS. 8a-b are schematic block diagrams illustrating embodiments of a control unit.

### DETAILED DESCRIPTION

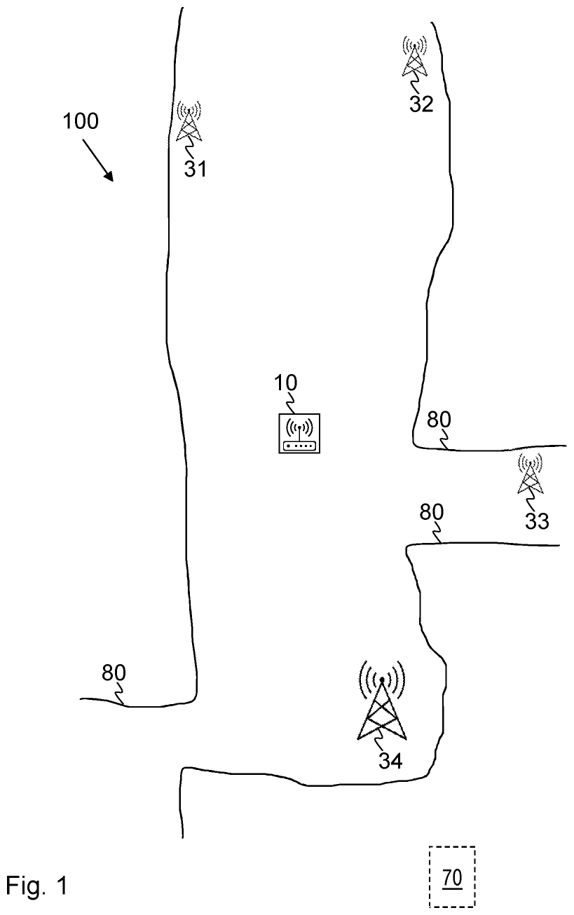

FIG. 1 is a schematic overview depicting an underground environment 100 of embodiments herein. The underground environment 100 comprises various passages and paths surrounded by rock walls 80. Due to being underground and/or due to the rock walls 80, special conditions for wireless network connections are present. This is since radio waves may not easily travel through the rock walls 80 in the underground environment 100, as these are typically very dense and unsuitable for radio propagation. Radio signals in the underground environment 100 may instead bounce in the underground environment 100 in a manner much different from normal environments for wireless communications, and hence, normal approaches for network communication or positioning thereof may not apply.

The underground environment 100 comprises one or more radio access points 31, 32, 33, 34 forming at least part of a communications network, e.g. connected to the Internet and/or any other suitable network. The one or more radio access points may comprise a first radio access point 31, a second radio access point 32, a third radio access point 33, and a fourth radio access point 34. While these four radio access points are depicted, the one or more radio access points may also comprise more than four radio access points. The one or more radio access points 31, 32, 33, 34 provide network connections to wireless devices in the underground environment 100. The one or more radio access points 31, 32, 33, 34 may be interconnected in any suitable manner. e.g. by switches and cables, and may also be connected to servers, base stations, and/or other networks. The one or more radio access points 31, 32, 33, 34 may use the same or different Radio Access Technology (RAT). As an example, the one or more radio access points 31, 32, 33, 34 may provide network connections over radio using any one or more suitable RAT such as e.g. any one or more out of Long Term Evolution (LTE), Fifth Generation New Radio (5G NR), Wi-Fi, Worldwide Interoperability for Microwave Access (WiMAX), Bluetooth, Bluetooth Low Energy (BLE). One or more respective positions of the one or more radio access points 31, 32, 33, 34 may be static/predetermined and/or obtainable by querying the one or more radio access points 31, 32, 33, 34 and/or a central server. The one or more radio access points 31, 32, 33, 34 may comprise any suitable network node for providing the above-mentioned RATs, e.g., such as any one or more out of: a base station, an eNodeB (eNB), a gNodeB (gNB), a router, a repeater, etc.

In the underground environment, one or more objects may be present, such as a first wireless device 10. The first wireless device 10 may be any suitable device that may have wireless capabilities e.g. for communicating actively and/or passively with any one or more out of the one or more radio access points 31, 32, 33, 34. The first wireless device 10 may be attached to a vehicle or machinery and may also be carried by a human. The first wireless device 10 may be an active device, e.g., capable of transmitting and receiving radio from the one or more radio access points 31, 32, 33, 34, and/or a passive device, e.g., a radio frequency tag, capable of being measured by other wireless devices and/or the one or more radio access points 31, 32, 33, 34.

Embodiments herein relate to determining a position of the first wireless device 20 in the underground environment 100. The position is determined based on a selected position estimation. The selected position estimation is selected out of a plurality of position estimations based on quality indicators indicating respective qualities of the plurality of position estimations in the underground environment 100. The plurality of position estimations and respective quality indicators may be obtained in any suitable manner using available different positioning services, e.g. pattern matching of paths in the underground environment with known movements of the first wireless device 10, dead reckoning techniques, radio triangulation, trilateration, signal strength/quality indicating closeness to radio access point etc. Positioning services as used herein may be any mechanism and/or methodology suitable for estimating a position in the underground environment 100.

Embodiments herein may be performed by any suitable control unit such as a control unit 70. The control unit 70 may form a system with the first wireless device 10. The control unit 70 may be located in any suitable location. For example, the control unit 70 may be located in the underground environment 100, or at a remote location, e.g. above ground. The control unit 70 may be part of a server but may also be part of a vehicle, e.g. carrying the first wireless device 10. The control unit 70 may also be co-located with any one of the radio access points 31, 32, 33, 34. Typically, the control unit 70 may communicate using a communications network which comprises the one or more radio access points 31, 32, 33, 34. The control unit 70 may therefore, in some embodiments, obtain the plurality of position estimations and/or respective quality indicators using information obtained by any one or more out of the one or more radio access points 31, 32, 33, 34.

A number of embodiments will now be described, which embodiments may be used in any suitable combination.

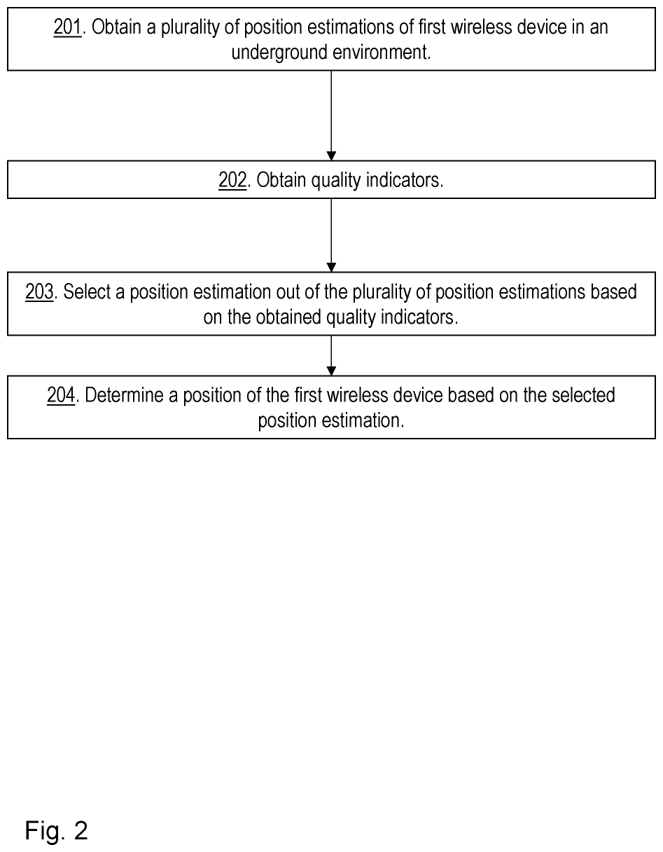

FIG. 2 illustrates an example embodiment of a method for determining a position of the first wireless device 10 in the underground environment 100. The method comprises the following actions, which actions may be performed in any suitable order.

Action 201. The method comprises obtaining a plurality of position estimations of the first wireless device 10 in the underground environment 100. The plurality of position estimations are obtained from different positioning services. The different positioning services may be any or more out of any suitable positioning service, e.g. one or more radio positioning services, dead reckoning techniques, map matching, pattern matching, etc., where some options will be exemplified further in embodiments herein. In other words, differently estimated positions of the first wireless device 10, estimated using respective independent positioning services may be obtained.

In some embodiments, the plurality of position estimations comprises one or more radio positioning estimations respectively estimated using one or more different radio positioning services. The one or more radio positioning estimations may comprise radio positioning using any one or more out of the radio positioning services: BLE, Wi-Fi, LTE, and NR. The radio positioning services may be used independently, or may be combined and used together. In some embodiments the radio positioning may comprise triangulation of the first wireless device 10. In some embodiments the radio positioning may comprise trilateration of the first wireless device 10. In some embodiments the radio positioning may comprise obtaining at least one position, e.g. predetermined, of at least one radio access point out of the one or more radio access points 31, 32, 33, 34 and determine a distance from the first wireless device 10 and the at least one radio access point based on the different RAT, e.g. any one or more out of BLE, Wi-Fi, LTE, and NR.

In some embodiments, the one or more radio positioning estimations are estimated when the first wireless device 10 broadcast a radio signal to any one or more respective access points of the one or more different radio positioning services. In other words, the first wireless device 10 broadcast the radio signal, and the radio signal may be received by at least one radio access point which may measure the signal e.g. to triangulate and/or to use trilateration to determine a positions and/or a distance to the first wireless device 10. Alternatively and/or additionally, it may also be possible to determine which of the one or more radio access points 31, 32, 33, 34, the first wireless device 10 is connected to, thus implying a certain distance to the connected radio access point. Using a determined distance to a radio access point and a position of a radio access point may be one way of estimating a position of the first wireless device.

In some embodiments, the plurality of position estimations comprises at least one position estimation estimated using a former position and a movement of the first wireless device 10. For example, dead reckoning techniques may use the former position of the first wireless device and use sensors to detect the movement of the first wireless device 10. The former position may be obtained in any suitable manner, e.g. using any of embodiments herein. When the first wireless device 10 is attached to a vehicle, vehicle sensors may be used for determining the movement of the first wireless device 10. Using the detected movement and the former position it is possible to estimate a current position. In this way, it is possible to estimate a position even when radio coverage is poor.

In some embodiments, the at least one position estimation is estimated by matching the former position and the movement of the first wireless device 10 with a predefined set of paths of the underground environment 100. The predefined set of paths in the underground environment 100 may be a map of the underground environment 100. Matching the former position and the movement of the first wireless device 10 with the predefined set of paths of the underground environment 100 may comprise determining a pattern of how the first wireless device 10 has moved from the former position and compare the determined pattern with the predefined paths. Using this comparison, it is possible to determine a closest set of path the first wireless device 10 have moved through in the predefined set of paths. In this way, it is possible to estimate a position with high accuracy even if errors in sensor reading may accumulate over time.

In some embodiments, obtaining the plurality of position estimations of the first wireless device 10 may comprise obtaining a position estimation from a second wireless device. The second wireless device may determine the position of the first wireless device 10 in any suitable manner. For example, the second wireless device may broadcast a signal and detect a response from a tag of the first wireless device 10. Using the response, it may be possible to determine a distance of the first wireless device 10 from the second wireless device. Furthermore, other sensors associated with the second wireless device may be used to estimate a position of the first wireless device 10. For example, the second wireless device may be part of a vehicle being capable of scanning the underground environment using any suitable sensor, e.g. using Light Detection and Ranging (Lidar) sensors.

Action 202. The method comprises obtaining quality indicators. The quality indicators indicate respective qualities of the plurality of position estimations in the underground environment 100. The indicated qualities may comprise any suitable quality, e.g. custom metrics, accuracies, confidences, precisions, etc. The quality indicators may be obtained with respective position estimations.

In some embodiments, at least one quality indicated by the quality indicators is based on a precision associated with a positioning service. The precision may be predetermined or determined when using an associated positioning service to obtain at least one position estimation, e.g. as in Action 201. The precision associated with the positioning service may indicate a maximum distance of error. In this way, the quality indicators may account for possible precision errors. For example, the quality indicators may indicate qualities weighted at least partially on their respective possible precision errors.

In some embodiments, the at least one quality indicated by the quality indicators is based on a time since the respective position estimation occurred. In this way, the quality indicators may account for the time since the respective position estimation occurred. For example, the quality indicators may indicate qualities weighted at least partially on their respective time, e.g. enabling filtering out old position estimations and/or having higher quality associated with newer position estimations.

In some embodiments, the at least one quality indicated by the quality indicators is based on a signal strength and/or signal quality between the first wireless device 10 and the one or more access points 31, 32, 33, 34 of the one or more different radio positioning services. In this way, the quality indicators may account for signal strength and/or signal quality. For example, the quality indicators may indicate qualities weighted at least partially on their respective signal strength and/or signal quality.

In some embodiments, the at least one quality indicated by the quality indicators is based on the respective position estimation. In this way, the quality indicators may indicate higher or lower qualities based on the location of the position estimation. For example, the quality indicators may indicate qualities weighted at least partially on whether their respective estimated position is known to have high or low quality position estimations. For example, it may be predetermined that a position of a position estimation in the plurality of position estimation has some advantageous and/or disadvantageous features which may affect a quality when estimating the position therein. E.g., when using radio for position estimation, and the estimated position is known to have a good radio coverage, the indicated quality may be known to be of high quality. If the estimated position is known to have poor radio coverage, the indicated quality may be known to be of low quality.

In some embodiments at least one respective quality indicator is received from the second wireless device, e.g. as detailed in Action 201 when the second wireless device is estimating the position of the first wireless device 10.

In other words, as indicated by above embodiments, a quality indicator of the above quality indicators may for one position estimation out of the plurality of position estimations indicate multiple qualities. For example, for two position estimations both precision and time since the position estimation was made may be part of the quality indicators. In this way, it is possible to determine which of the two position estimations are of highest quality, e.g. as it is possible to derive a maximum error since the positions were estimated. As another example, for a first and second position estimations signal strength is part of the quality indicators which indicates signal strength and a quality based on the estimated position. The indicated signal strengths may be the same, but their respective estimated positions may indicate different qualities e.g. due to radio coverage of the respective estimated positions.

In some embodiments obtaining the quality indicators comprises estimating at least one quality metric of the plurality of position estimations. For example, using the indicates qualities, it may be possible to estimate the at least one quality metric for any of the position estimations in the plurality of the position estimations. The at least one quality metric may be a quality metric weighted based on the indicated respective qualities and/or may be a multi-dimensional metric. The at least one quality metric may indicate an aggregated quality of a position estimation, and is comparable to other similar quality metrics such that it is possible to evaluate which position estimate has the highest quality. For example, the indicated qualities, e.g. based on any one or more out of precision, determined precision, signal strength, signal quality, estimated position, time, etc., may comprise a separate metric, or comprise a coefficient for estimating the at least one quality metric.

In some embodiments, obtaining the quality indicators may comprise normalizing the qualities indicated by the quality indicators and/or the at least one quality metric such that they may be compared using any suitable arithmetic operation to determine which position estimation out of the plurality of position estimations is of highest quality. For example, each different quality may be associated with a reference quality value, such that each indicated quality may be represented as a normalized score based on the respective reference value.

Action 203. The method comprises selecting a position estimation out of the plurality of position estimations based on the obtained quality indicators. Since the quality indicators indicate respective quality of the plurality of position estimations in the underground environment 100, it is enabled to select the position estimation out of the plurality of position estimations with the best indicated quality. In other words, the highest quality position estimation out of the plurality of position estimations may be selected.

Action 204. The method comprises determining the position of the first wireless device 10 based on the selected position estimation. Determining the position of the first wireless device 10 may e.g. comprise using the selected position estimation as the determined position and/or by determining co-ordinates in the underground environment 100 based on the selected position estimation. Since the selected position estimation may be selected with the highest quality, the determined position may be as accurate as possible given the available different positioning services.

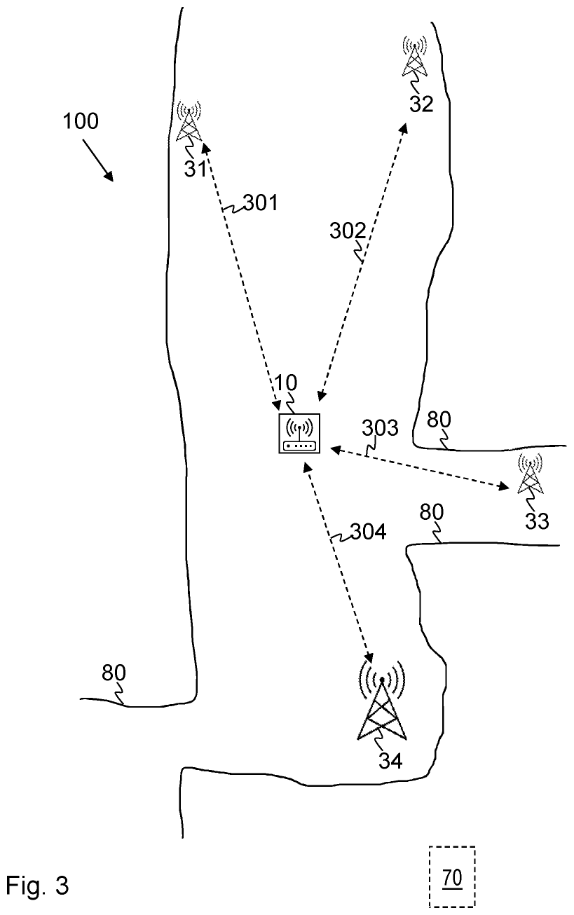

FIG. 3 illustrates an example scenario wherein the plurality of position estimations comprises one or more radio positioning estimations. The radio positioning estimations may respectively be estimated using one or more different radio positioning services, e.g. as in Action 201. As example, the one or more radio access points 31, 32, 33, 34 may comprise any of: one or more BLE access points, one or more Wi-Fi access points, one or more LTE access points, one or more NR access points, or any combination thereof. In this example scenario, the radio positioning estimations may be estimated based on:
at least one first radio signal 301 transmitted between the first radio access point 31 and the first wireless device 10,
at least one second radio signal 302 transmitted between the second radio access point 32 and the first wireless device 10,
at least one third radio signal 303 transmitted between the third radio access point 31 and the first wireless device 10, and
at least one fourth radio signal 304 transmitted between the fourth radio access point 31 and the first wireless device 10.

The position of the first wireless device 10 may be estimated, based on any one or more of the transmitted radio signals 301-304 to be a distance from the respective radio access point. The position estimations may be used independently or in combination, e.g. for triangulation and/or trilateration.

Trilateration as used herein may mean an estimating process comprising determining distances to multiple radio access points out of the one or more radio access points 31, 32, 33, 34, e.g. using a signal strength, and derive a position estimation of the first wireless device 10 thereof.

Triangulation as used herein may mean an estimating process comprising obtaining at least one distance between at least two radio access points of the one or more radio access points 31, 32, 33, 34, e.g. predetermined; determining distances from the first wireless device 10 and the at least two radio access points, e.g. using a signal strength, and derive a position estimation of the first wireless device thereof.

The radio positioning estimations may be performed by the respective radio access points 31, 32, 33, 34, and/or the first wireless device 10. Any one or more out of the radio access points 31, 32, 33, 34 may use any suitable RAT, e.g., different or same from other radio access points in the one or more radio access points. Alternatively, the information of the transmitted radio signals, e.g. measured signal strength and/or signal quality, may be transmitted to the control unit 70 which may perform the radio positioning estimations. The radio signals 301, 302, 303, 304 may have differing qualities due to having different signal strengths and/or signal qualities as indicated in the obtained quality indicators, e.g. as in Action 202, wherein higher signal strength and/or signal quality may increase indicated quality. Furthermore, the radio signals 301, 302, 302, 304 may be transmitted at different time periods, e.g. as different technologies may transmit using different periodicities, and as such, the newer radio positioning estimations may increase indicated qualities. Furthermore, different RATs may be associated with different precisions, e.g. any one or more out of: at least one RAT may utilize a higher frequency which is associated with a higher precision and/or accuracy in estimating positions but may instead be less robust, at least one RAT may be associated with a high precision and/or accuracy for one or more specific area locations, at least one RAT may be associated with a poor precision and/or accuracy for one or more specific area locations, at least one RAT may be associated with a precision and/or accuracy based on previous measurements. The qualities may be weighted due to many different configurations and contexts. This means that the lowest signal strength of the radio signals 301, 302, 303, 304, may in some scenarios be associated with a radio positioning estimation of highest quality if e.g. the radio positioning estimation also has the most recent radio positioning estimations and has the highest precision. Likewise, the radio positioning estimation of the lowest precision may in some scenarios be associated with a radio positioning estimation of highest quality, for example if the radio positioning estimation is the most recent of the radio positioning estimations and has a high quality signal strength. The term high quality signal strength may for example mean that the signal strength is over a threshold. The threshold may be that the signal strength is measurable, that it is over a set value, over a dynamic threshold that is statistically defined etc.

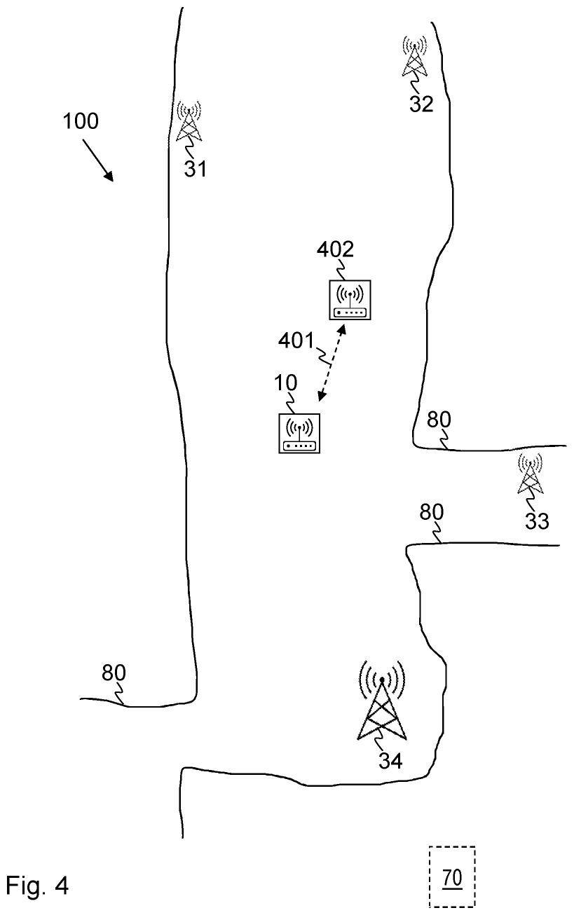

FIG. 4 illustrates an example scenario wherein the plurality of position estimations comprises at least one position estimation estimated by a second wireless device 402. The second wireless device 402 may estimate the position of the first wireless device 10 by means of a radio signal 401 transmitted between the first wireless device 10 and the second wireless device 402. The quality of the position estimated by the second wireless device 402 may be based on a signal strength and/or a signal quality of the transmitted radio signal 401. The position estimation and associated quality may be transmitted to the control unit 70, e.g. via the radio access points 31, 32, 33, 34.

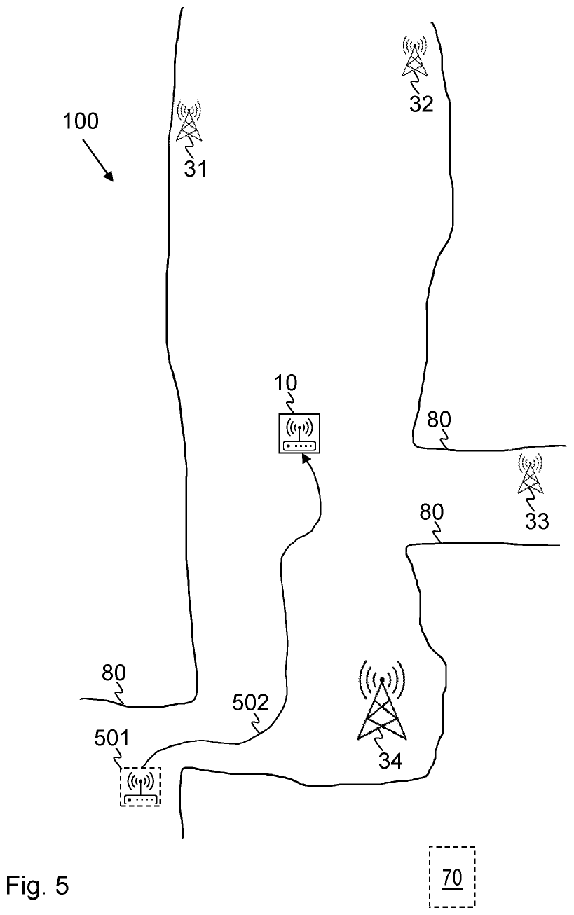

FIG. 5 illustrates an example scenario wherein the plurality of position estimations comprises at least one position estimation estimated using a former position 501 of the first wireless device 10 and a movement 502 of the first wireless device 10. The former position may be determined in any suitable manner, e.g. as in actions 201-204 above or set by a user. The former position may also be determined above ground, e.g. by GPS before the first wireless device moves underground. The movement 502 may indicate a path travelled by the first wireless device 10. When the first wireless device 10 is part of a vehicle, the movement 502 may be determined by dead reckoning techniques by the use of sensors on the vehicle, e.g. by measuring how wheels of a vehicle is moving etc. The quality of the estimated position may be determined based on estimating accumulated errors e.g. when measuring sensors for dead reckoning. In some embodiments, the at least one position estimation is estimated by matching the former position 501 and the movement 502 with a predefined set of paths of the underground environment 100. The predefined set of paths may be a map of the underground environment 100. This may be referred to as pattern matching positioning. The position estimation and associated quality may be transmitted to the control unit 70, e.g. via the radio access points 31, 32, 33, 34.

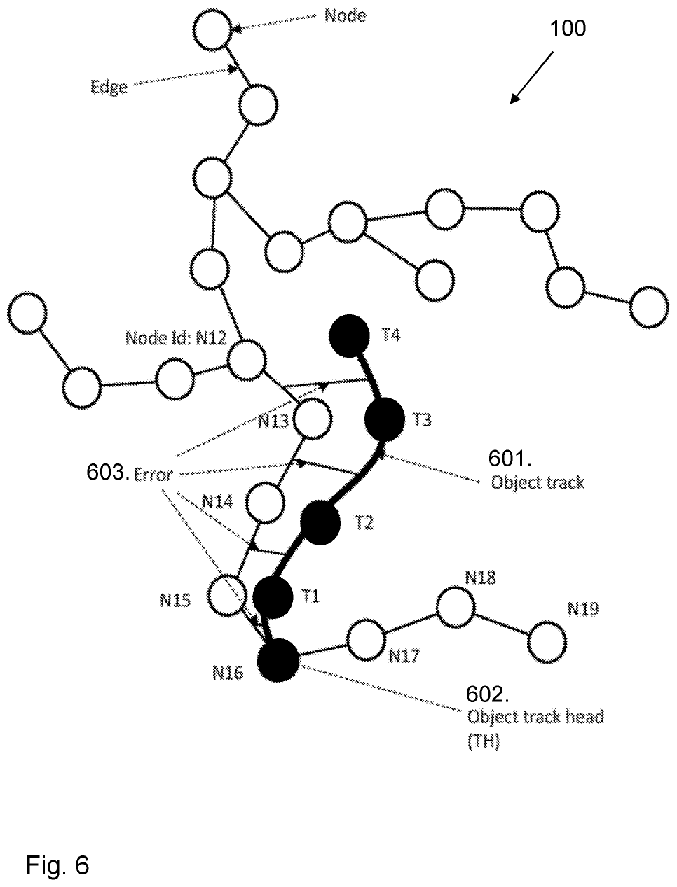

FIG. 6 illustrates an example scenario wherein the plurality of position estimations comprises at least one position estimation estimated by matching a former position and a movement of the first wireless device 10 with a predefined set of paths of the underground environment 100. The predefined set of paths is in the example scenario represented by a plurality of nodes N1-N19, i.e. representing positions in the predefined set of paths. The nodes N1-N19 corresponds to positions in the underground environment 100. Based on the former position of the first wireless device 10 and a movement of the first wireless device 10, a pattern of nodes T1-T4 representing a tracked movement of the first wireless device 10 may be estimated. In this scenario, the position of the first wireless device 10 may be estimated by pattern matching between a first pattern representing an object track 601 of a movement undertaken by the first wireless device 10 and a second pattern representing the underground environment 100 in which the tracked movement has been undertaken by the first wireless device 10. The object track 601 have an object Track Head (TH) 602 and a tail, the TH 602 represents a current position of the first wireless device 10. The pattern representing the underground environment 100 may be a discretized pattern representing the underground environment 100. The predefined set of paths may represent a plurality of nodes representing positions in the predefined set of paths. Estimating a position of the first wireless device 10, e.g. as part of obtaining the plurality of position estimations in Action 201, may comprise any one or more out of:
when a matching error 603 in a current position of the first wireless device 10 exceeds a first threshold, determining nodes N1, . . . Nn of a pattern representing the underground environment 100 for which pattern matching is to be carried out utilizing a non-pattern matching positioning method, e.g. any other position estimation method of embodiments herein,
when the matching error 603 in the current position of the first wireless device 10 is below the first threshold, determining one or more nodes N1, . . . Nn of the pattern representing the environment for which pattern matching is to be carried out based on one or more nodes N1, . . . Nn of the pattern representing the underground environment 100 previously determined and/or estimated to be the position of the first wireless device 10, and
estimating the current position of the first wireless device 10 as a node for which the pattern matching results in a matching error 603 below the first threshold.

For the position estimation in the example scenario of FIG. 6, the quality of the position estimation may correspond to, or be represented by the matching errors 603 and/or the matching error of the TH 602, e.g., an average of the errors 603.

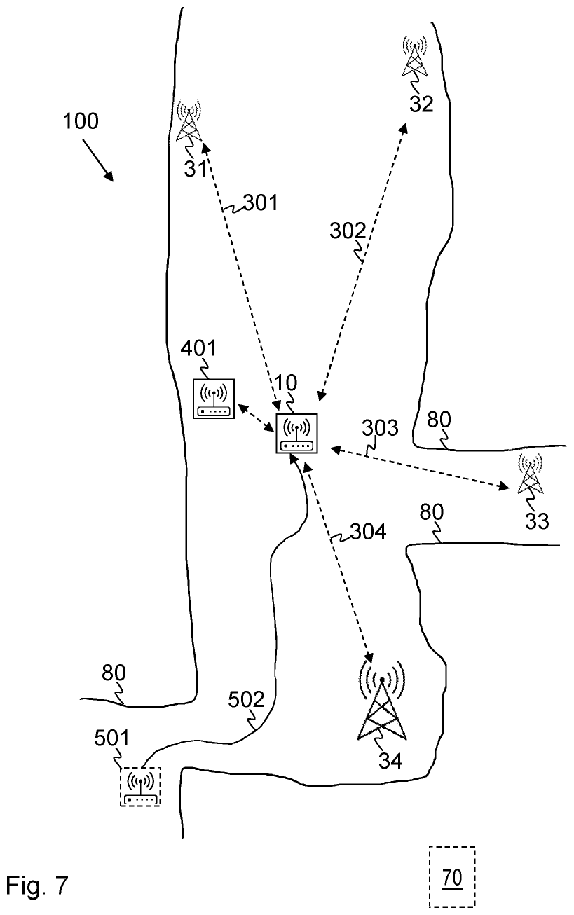

FIG. 7 illustrates an example scenario wherein the plurality of position estimations, e.g. as obtained in Action 201 above, comprises several of the presented optional position estimations of embodiments herein.

The plurality of position estimations of the example scenario comprises radio positioning estimations of the position of the first wireless device 10 using the radio signals 301-304 transmitted between the radio access points 31, 32, 33, 34 and the first wireless device 10. The radio positioning estimations may comprise estimating a distance between the respective radio access point 31, 32, 33, 34 of a predefined position and the first wireless device 10. The respective quality and/or strength of the radio signals 301-304, as well as their respective precisions may indicate the quality of respective position estimations, e.g. as obtained in Action 202 above.

Furthermore the plurality of position estimations of the example scenario comprises the second wireless device 401 estimating the position of the first wireless device 10 by reading the radio frequency tag of the first wireless device 10. The quality of the position estimation, e.g. as obtained in Action 202 above, may be estimated by the combination of the quality of the position estimation of the second wireless device 401 and quality of response when reading the radio frequency tag of the first wireless device 10.

Furthermore, the plurality of position estimations of the example scenario comprises estimating a position of the first wireless device 10 by the use of the former position 501 of the first wireless device 10 and the indicated or tracked movement 502 of the first wireless device 10, e.g. using dead reckoning or pattern matching. The quality e.g. as obtained in Action 202, may be estimated based on errors in the pattern matching and/or dead reckoning.

The control unit 70 may then select the highest quality position estimation and determine the position of the first wireless device 10 based on the selected position estimation, e.g. as in actions 203-204 above.

Alternatively or additionally, estimating a position of the first wireless device 10, e.g. as part of obtaining the plurality of positions, e.g. as in Action 201, may further comprise any other suitable method for estimating a position of the first wireless device 10.

To perform embodiments herein, e.g. the method according to actions 201-204 above, may be performed by the control unit 70. The control unit 70 may be arranged in a centralized location, e.g. as part of a server or a cloud service, or may be located in the mine, e.g. co-located with the first wireless device 10. The control unit 70 is configured to determine a position of the first wireless device 10 in the underground environment 100 The control unit 70 may also be arranged in a system with the first wireless device 10, e.g. the system being configured to perform the method according to actions 201-204. Advantages and effects of the control unit are analogous to the advantages and effects of the method described in actions 201-204. Further, all embodiments of the control unit 70 are applicable to and combinable with all embodiments of actions 201-204.

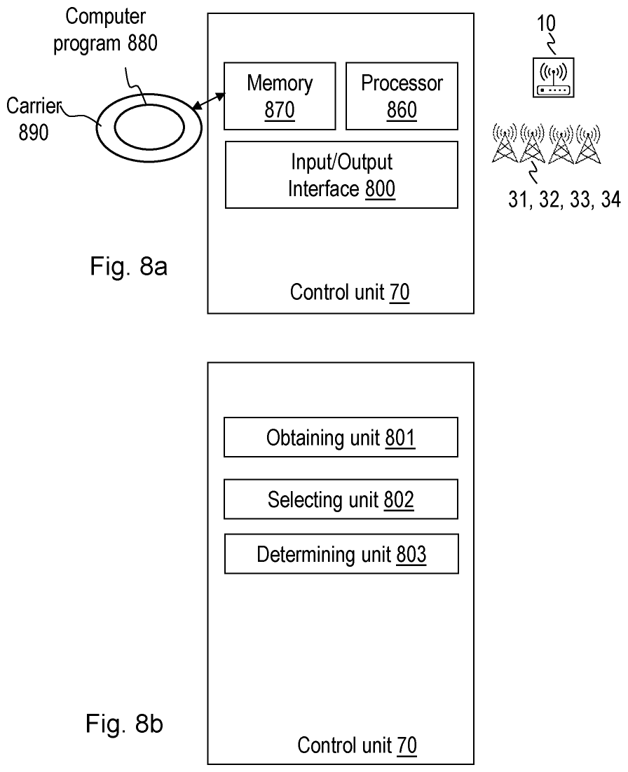

The control unit 70 may comprise an arrangement depicted in FIGS. 8a and 8b. The control unit 70 may comprise an input and output interface 800 e.g. for communicating with the first wireless device 10 and/or the radio access points 31, 32, 33, 34.

The input and output interface 800 may comprise a wireless or wired receiver (not shown), a transceiver, one or more antennas, and/or a wired or wireless transmitter (not shown).

The control unit 70 is configured to, e.g. by means of an obtaining unit 801 in the the control unit 70, obtain the plurality of position estimations of the first wireless device 10 in the underground environment 100. The plurality of position estimations are obtained from different positioning services.

The control unit 70 is configured to, e.g. by means of the obtaining unit 801 in the the control unit 70, obtain the quality indicators indicating the respective qualities of the plurality of position estimations in the underground environment 100.

In some embodiments, the at least one quality indicated by the quality indicators is based on the precision associated with the positioning service. In some embodiments, the precision is determined when using the associated positioning service to obtain at least one position estimation. In some embodiments, the at least one quality indicated by the quality indicators is based on the time since the respective position estimation occurred. In some embodiments, the at least one quality indicated by the quality indicators is based on the respective position estimation.

The control unit 70 is configured to, e.g. by means of a selecting unit 802 in the the control unit 70, select the position estimation out of the plurality of position estimations based on the obtained quality indicators.

The control unit 70 is configured to, e.g. by means of a determining unit 803 in the the control unit 70, determine the position of the first wireless device 10 based on the selected position estimation.

The embodiments herein may be implemented through one or more processors, such as a processor 860 of a processing circuitry in the control unit 70, depicted in FIG. 8a, together with a computer program 880 comprising instructions, which when executed by a processor, causes the processor to perform the functions and actions of the embodiments herein.

In some embodiments, a respective carrier 890 comprises the respective computer program 880, wherein the carrier 890 is one of an electronic signal, an optical signal, an electromagnetic signal, a magnetic signal, an electric signal, a radio signal, a microwave signal, or a computer-readable storage medium. For example, one such carrier may be in the form of a CD ROM disc or a memory stick. The computer program 880 may furthermore be provided as pure program code on a server and downloaded to the control unit 70.

The control unit 70 may further comprise a memory 870 comprising one or more memory units. The memory 870 comprises instructions executable by the processor in the control unit 70. The memory 870 is arranged to be used to store e.g. information, indications, data, configurations, position estimations, quality indicators, and applications to perform the embodiments herein when being executed in the control unit 70.

Those skilled in the art will appreciate that the units in the control unit 70 described above may refer to a combination of analog and digital circuits, and/or one or more processors configured with software and/or firmware, e.g. stored in the control unit 70, that when executed by the respective one or more processors such as the processors described above. One or more of these processors, as well as the other digital hardware, may be included in a single Application-Specific Integrated Circuitry (ASIC), or several processors and various digital hardware may be distributed among several separate components, whether individually packaged or assembled into a system-on-a-chip (SoC).

When using the word “comprise” or “comprising” it shall be interpreted as non-limiting, i.e. meaning “consist at least of”.

It will be appreciated that the foregoing description and the accompanying drawings represent non-limiting examples of the methods and apparatus taught herein. As such, the apparatus and techniques taught herein are not limited by the foregoing description and accompanying drawings. Instead, the embodiments herein are limited only by the following claims and their legal equivalents.

1. A method for determining a position of a first wireless device in an underground environment, the method comprising:
obtaining a plurality of position estimations of the first wireless device in the underground environment, wherein the plurality of position estimations are obtained from different positioning services,
obtaining quality indicators indicating respective qualities of the plurality of position estimations in the underground environment,
selecting a position estimation out of the plurality of position estimations based on the obtained quality indicators, and
determining the position of the first wireless device based on the selected position estimation.

2. The method according to claim 1, wherein at least one quality indicated by the quality indicators is based on a precision associated with a positioning service.

3. The method according to claim 2, wherein the precision is determined when using the associated positioning service to obtain at least one position estimation.

4. The method according to claim 1, wherein at least one quality indicated by the quality indicators is based on a time since the respective position estimation occurred.

5. The method according to claim 1, wherein at least one quality indicated by the quality indicators is based on the respective position estimation.

6. The method according to claim 1, wherein the plurality of position estimations comprises one or more radio positioning estimations respectively estimated using one or more different radio positioning services, and wherein at least one quality indicated by the quality indicators is based on a signal strength and/or signal quality between the first wireless device and one or more access points of the one or more different radio positioning services.

7. The method according to claim 6, wherein the one or more different radio positioning services comprises radio positioning using any one or more out of:
Bluetooth Low Energy (BLE),
Wi-Fi,
Long Term Evolution (LTE), and
5G New Radio (NR).

8. The method according to claim 6, wherein the one or more radio positioning estimations are estimated when the first wireless device broadcast a radio signal to any one or more respective access points of the one or more different radio positioning services.

9. The method according to claim 1, wherein the plurality of position estimations comprises at least one position estimation estimated using a former position and a movement of the first wireless device.

10. The method according to claim 9, wherein the at least one position estimation is estimated by matching the former position and the movement of the first wireless device with a predefined set of paths of the underground environment.

11. The method according to claim 1, wherein obtaining the plurality of position estimations of the first wireless device comprises obtaining a position estimation and a respective quality indicator from a second wireless device.

12. The method according to claim 1, wherein obtaining the quality indicators comprises estimating at least one quality metric of the plurality of position estimations.

13. A control unit configured to determine a position of a first wireless device in an underground environment, the control unit is further configured to:
obtain a plurality of position estimations of the first wireless device in the underground environment, wherein the plurality of position estimations are obtained from different positioning services,
obtain quality indicators indicating respective qualities of the plurality of position estimations in the underground environment,
select a position estimation out of the plurality of position estimations based on the obtained quality indicators, and
determine the position of the first wireless device based on the selected position estimation.

14. The control unit according to claim 13, wherein at least one quality indicated by the quality indicators is based on a precision associated with a positioning service.

15. The control unit according to claim 14, wherein the precision is determined when using the associated positioning service to obtain at least one position estimation.

16. The control unit according to claim 13, wherein at least one quality indicated by the quality indicators is based on a time since the respective position estimation occurred.

17. The control unit according to claim 13, wherein at least one quality indicated by the quality indicators is based on the respective position estimation.

18. A system for determining a position of a first wireless device in an underground environment, wherein the system is comprising a control unit and the first wireless device, the system being configured to perform the method according to claim 1.

19. A computer program comprising instructions, which when executed by a processor, causes the processor to perform actions according to the method of claim 1.

20. (canceled)
